(19) United States
(12) Patent Application Publication
(10) Pub. No.: US 2024/0258604 A1
(43) Pub. Date: Aug. 1, 2024

(54) THERMALLY CONDUCTIVE, ELECTRICALLY INSULATING FILM AND BATTERY PACK COMPRISING SAME

(71) Applicant: Illinois Tool Works Inc., Glenview, IL (US)

(72) Inventor: Fanliang MENG, Shanghai (CN)

(21) Appl. No.: 18/563,688

(22) PCT Filed: May 27, 2022
(86) PCT No.: PCT/US2022/031242

§ 371 Date: Nov. 22, 2023

(30) Foreign Application Priority Data
May 27, 2021 (CN) 202110584016.1
Apr. 18, 2022 (CN) 202210404208.4

(51) Int. Cl. H01M 10/653; C08J 5/18; C08K 3/22; C08K 3/38; C08K 5/06; C08K 7/00; C08K 13/04; C09K 5/14; H01M 50/383

(52) U.S. Cl. CPC H01M 10/653; C08J 5/18; C08K 13/04; C09K 5/14; H01M 50/383; C08J 2323/12; C08K 2003/222; C08K 2003/2227; C08K 2003/385; C08K 5/06; C08K 7/00; C08K 2201/001; C08K 2201/005; C08K 2201/012; C08K 2201/014

(57) ABSTRACT

The present application discloses a thermally conductive, electrically insulating film comprising: a thermoplastic resin accounting for 15-50% of the weight of the thermally conductive, electrically insulating film, and a thermally conductive filler accounting for 40-70% of the weight of the thermally conductive, electrically insulating film; wherein the thermally conductive filler comprises: a thermally conductive carbon-based filler, a thermally conductive metal oxide or hydroxide filler and a thermally conductive ceramic filler. The thermally conductive, electrically insulating film is used in electronic products or devices to not only impart excellent heat dissipation capability to electronic products and devices, but also meet the insulativity requirement for electronic products and devices. Meanwhile, such a thermally conductive, electrically insulating film further features excellent flame retardancy and mechanical properties to meet the requirements of the operating environment.

### TECHNICAL FIELD

The present application relates to the field of thin films, and particularly relates to a thermally conductive, electrically insulating film and a battery pack comprising the thermally conductive, electrically insulating film.

### BACKGROUND

Electronic products or devices generate a large amount of heat during operation. For the purpose of ensuring the operating stability of the electronic products and devices and extending their service life, it is desired that the electronic products or devices have excellent heat dissipation capability. Thermally conductive materials are used in electronic products and devices to impart excellent heat dissipation capability to electronic products and devices. Since thermally conductive materials are used in electronic products and devices, it is desirable that the thermally conductive materials also have excellent electrical insulation performance.

### SUMMARY

The objective of the present application is to provide a thermally conductive, electrically insulating film for use in electronic products or devices to not only impart excellent heat dissipation capability to electronic products and devices, but also meet the insulativity requirement for electronic products and devices. Meanwhile, such a thermally conductive, electrically insulating film further features excellent flame retardancy and mechanical properties to meet the requirements of the operating environment.

In the first aspect, the present application provides a thermally conductive, electrically insulating film comprising: a thermoplastic resin accounting for 15-50% of the weight of the thermally conductive, electrically insulating film, and a thermally conductive filler accounting for 40-70% of the weight of the thermally conductive, electrically insulating film; wherein the thermally conductive filler comprises: a thermally conductive carbon-based filler, a thermally conductive metal oxide or hydroxide filler and a thermally conductive ceramic filler.

According to the aforesaid first aspect, the thermally conductive carbon-based filler accounts for 2-15% of the weight of the thermally conductive, electrically insulating film.

According to the aforesaid first aspect, the thermally conductive carbon-based filler accounts for 10-15% of the weight of the thermally conductive, electrically insulating film.

According to the aforesaid first aspect, the thermally conductive carbon-based filler is one or more fillers selected from graphite, carbon nanotube and graphene.

According to the aforesaid first aspect, the graphite is at least one graphite selected from flake graphite and expanded graphite.

According to the aforesaid first aspect, the thermally conductive carbon-based filler is flake graphite.

According to the aforesaid first aspect, the graphite has a particle size ranging from 10 nm to 200 μm, the carbon nanotube has a diameter ranging from 2 to 200 nm, and the graphene has a diameter-to-thickness ratio ranging from 500 to 8000.

According to the aforesaid first aspect, the thermally conductive metal oxide or hydroxide filler accounts for 5-55% of the weight of the thermally conductive, electrically insulating film.

According to the aforesaid first aspect, the thermally conductive metal oxide or hydroxide filler accounts for 20-50% of the weight of the thermally conductive, electrically insulating film.

According to the aforesaid first aspect, the thermally conductive metal oxide or hydroxide filler comprises one or more fillers selected from magnesium oxide, zinc oxide, aluminum oxide, magnesium hydroxide and aluminum hydroxide.

According to the aforesaid first aspect, the thermally conductive metal oxide or hydroxide filler is granular.

According to the aforesaid first aspect, the thermally conductive ceramic filler accounts for 2-50% of the weight of the thermally conductive, electrically insulating film.

According to the aforesaid first aspect, the thermally conductive ceramic filler accounts for 5-40% of the weight of the thermally conductive, electrically insulating film.

According to the aforesaid first aspect, the thermally conductive ceramic filler comprises one or more fillers selected from boron nitride, silicon carbide, and aluminum nitride.

According to the aforesaid first aspect, the thermally conductive ceramic filler is flaky or spherical.

According to the aforesaid first aspect, the thermoplastic resin is polypropylene resin.

According to the aforesaid first aspect, the thermally conductive, electrically insulating film further comprises a flame retardant accounting for 10-45% of the weight of the thermally conductive, electrically insulating film.

According to the aforesaid first aspect, the flame retardant is at least one compound selected from phosphorus/nitrogen-containing flame retardant, phosphorus/nitrogen/silicon-containing flame retardant, and brominated flame retardant.

In the second aspect, the present application provides a battery pack comprising: a battery pack housing comprising a bottom wall and side walls; a battery pack module disposed inside the battery pack housing; and a thermally conductive, electrically insulating film disposed between the battery pack module and at least one of the bottom wall and side walls of the battery pack housing; wherein the thermally conductive, electrically insulating film is as claimed for the first aspect.

### BRIEF DESCRIPTION OF THE DRAWINGS

FIG. 1 is a schematic structure diagram for one embodiment of the battery pack comprising the thermally conductive, electrically insulating film according to the present application.

### DETAILED DESCRIPTION

Various embodiments of the present application are described below by referring to the attached drawing which constitutes a part of the Specification. It should be understood that although terms indicating directions used herein, such as “front”, “rear”, “above”, “underneath”, “left”, “right, “top”, “bottom”, “inside”, “outside”, depict various exemplary structure parts and elements of the present application, these terms are used herein for the convenience of description and are determined based on the exemplary directions indicated in the attached drawing. Since the embodiments disclosed herein may be disposed in different directions, these terms indicating directions are intended for illustrative purposes and are not to be construed as restrictions.

In the present application, unless otherwise specified, all devices and raw materials are commercially available or commonly used in the art. Unless otherwise specified, the methods mentioned in the embodiments below are common methods in the art.

The thermally conductive, electrically insulating film of the present application comprises a thermoplastic resin and a thermally conductive filler. The thermoplastic resin accounts for 15-50% of the total weight of the thermally conductive, electrically insulating film, and the thermally conductive filler accounts for 40-70% of the total weight of the thermally conductive, electrically insulating film. In some embodiments, the thermoplastic resin accounts for 17.5-32.5% of the total weight of the thermally conductive, electrically insulating film. In some embodiments, the thermally conductive filler accounts for 40-65% of the total weight of the thermally conductive, electrically insulating film. Wherein, the thermally conductive filler comprises three types: thermally conductive carbon-based filler, thermally conductive metal oxide or hydroxide filler and thermally conductive ceramic filler.

The thermoplastic resin is polypropylene resin. Wherein, the polypropylene resin is homopolymerized or copolymerized polypropylene having a melt flow index of 0.1-100 g/10 min (230° ° C., 2.16 kg). In other embodiments, other thermoplastic resins may be used, such as polyethylene, polyvinyl chloride, polycarbonate, etc.

The thermally conductive carbon-based filler is one or more fillers selected from graphite, carbon nanotube and graphene. Wherein, the graphite is at least one graphite selected from flake graphite and expanded graphite. The graphite has a particle size ranging from 10 nm to 200 μm, the carbon nanotube has a diameter ranging from 2 to 200 nm, and the graphene has a diameter-to-thickness ratio ranging from 500 to 8000. In some embodiments, the thermally conductive carbon-based filler is flake graphite. The addition of the thermally conductive carbon-based filler imparts excellent thermal conduction capability to the thermally conductive, electrically insulating film. However, since the thermally conductive carbon-based filler has an electrical conduction property, it is generally uncommon to think of adding a thermally conductive carbon-based filler into a product that is required to be insulative. Surprisingly, the inventors of the present application have found that controlling the amount of the thermally conductive carbon-based filler at 2-15% of the total weight of the thermally conductive, electrically insulating film enables the thermally conductive, electrically insulating film to have excellent thermal conduction performance and good electrical insulation performance. In some embodiments, the thermally conductive carbon-based filler accounts for 10-15% of the total weight of the thermally conductive, electrically insulating film.

The thermally conductive metal oxide or hydroxide filler accounts for 5-55% of the total weight of the thermally conductive, electrically insulating film. In some embodiments, the thermally conductive metal oxide or hydroxide filler accounts for 20-50% of the total weight of the thermally conductive, electrically insulating film. The thermally conductive metal oxide or hydroxide filler comprises one or more fillers selected from magnesium oxide, zinc oxide, aluminum oxide, magnesium hydroxide and aluminum hydroxide. The thermally conductive metal oxide or hydroxide filler is granular.

The thermally conductive ceramic filler accounts for 2-50% of the total weight of the thermally conductive, electrically insulating film. In some embodiments, the thermally conductive ceramic filler accounts for 5-40% of the total weight of the thermally conductive, electrically insulating film. The thermally conductive ceramic filler is one or more fillers selected from boron nitride, silicon carbide, and aluminum nitride. The thermally conductive ceramic filler is flaky or spherical. The thermally conductive ceramic filler has excellent thermal conduction performance, so it imparts outstanding thermal conduction performance to the thermally conductive, electrically insulating film of the present application.

In some embodiments, in response to the flame retardancy requirement, the thermally conductive, electrically insulating film further comprises a flame retardant accounting for 10-45% of the total weight of the thermally conductive, electrically insulating film. In some embodiments, the flame retardant accounts for 10-26% of the total weight of the thermally conductive, electrically insulating film. In some embodiments, the flame retardant is at least one compound selected from phosphorus/nitrogen-containing flame retardant, phosphorus/nitrogen/silicon-containing flame retardant, and brominated flame retardant. In some embodiments, the flame retardant further comprises an auxiliary flame retardant, and the auxiliary flame retardant is one or more compounds selected from antimony trioxide, and borate. The thermally conductive, electrically insulating film of the present application has a surface resistivity up to 10¹²Ω·m.

In some embodiments, the thermally conductive, electrically insulating film further comprises one or more of the following compounds as needed, expressed in weight percent relative to the total weight of the thermally conductive, electrically insulating film: 0-10% toughening agent, 0-5% compatibilizer, 0.1-1% lubricant, 0-1.5% antioxidant, and 0-2% toner. In some embodiments, the compatibilizer accounts for 0-3% of the total weight of the thermally conductive, electrically insulating film. In some embodiments, the lubricant accounts for 0.2-0.5% of the total weight of the thermally conductive, electrically insulating film. The toughening agent comprises one or more compounds selected from propylene-based elastomer, styrenic elastomer (such as hydrogenated poly(styrene-b-isoprene), hydrogenated poly(styrene-b-butadiene-b-styrene), hydrogenated poly(styrene-b-isoprene-b-styrene) and hydrogenated poly(styrene-b-isoprene/butadiene-b-styrene)), copolymerized polyolefin elastomer (such as ethene-octene copolymer, ethene-butene copolymer, ethene-hexene copolymer), and polyethylene. The compatibilizer comprises one or more compounds selected from alkyl silane coupling agent, maleic anhydride grafted polyethylene, maleic anhydride grafted polypropylene, and maleic anhydride grafted polyolefin elastomer (POE). The lubricant comprises one or more compounds selected from silicon lubricant, amide lubricant, stearic acid lubricant, and polytetrafluoroethylene. The antioxidant comprises one or more compounds selected from hindered phenolic antioxidant, phosphite antioxidant, and sulfur-containing antioxidant. As mentioned above, the thermally conductive carbon-based filler, the thermally conductive granular metal oxide or hydroxide filler and the thermally conductive flaky ceramic filler used in the thermally conductive, electrically insulating film of the present application have excellent thermal conduction performance, so the thermally conductive, electrically insulating film of the present application also has outstanding thermal conduction performance.

Furthermore, the thermal conduction performance of the thermally conductive, electrically insulating film of the present application is further improved by the synergic action of the three thermally conductive fillers used in the thermally conductive, electrically insulating film of the present application. Specifically, the inventors of the present application have found that the thermally conductive flaky ceramic filler is able to connect the thermally conductive carbon-based filler with the thermally conductive granular metal oxide or hydroxide filler to form a thermal-conducting channel inside the thermally conductive, electrically insulating film, which further improves the thermal conduction performance of the thermally conductive, electrically insulating film. The thermally conductive spherical ceramic filler is formed by controlling the crystal growth direction of the thermally conductive flaky ceramic filler. Since the thermally conductive spherical ceramic filler is obtained from the thermally conductive flaky ceramic filler, the thermally conductive spherical ceramic filler exhibits the aforesaid advantages of the thermally conductive flaky ceramic filler. In addition, since the thermally conductive spherical ceramic filler is isotropic, the thermally conductive spherical ceramic filler also facilitates the thermal conduction along the flake plane to further improve the thermal conduction performance of the thermally conductive, electrically insulating film.

Moreover, the selection of the thermally conductive filler for the present application ensures that the thermally conductive, electrically insulating film has excellent thermal conduction performance despite the use of a reduced amount of thermally conductive filler. The thermal conductivity of the thermally conductive, electrically insulating film of the present application reaches 1-1.46 W/m·K.

Further, since the thermally conductive, electrically insulating film of the present application has excellent thermal conduction performance and contains a reduced amount of thermally conductive filler, the thermally conductive, electrically insulating film of the present application has improved mechanical properties. The inventors of the present application have found that a large amount of thermally conductive filler is required in order to prepare a film with excellent thermal conduction performance using a thermoplastic resin. The larger the amount of thermally conductive filler used and the smaller the amount of the thermoplastic resin used, the worse the mechanical properties of the thermally conductive, electrically insulating film. Through the selection of the thermally conductive filler, a reduced amount of thermally conductive filler can be used for the thermally conductive, electrically insulating film of the present application, thereby increasing the proportion of the thermoplastic resin in the thermally conductive, electrically insulating film. Therefore, the thermally conductive, electrically insulating film of the present application has improved mechanical properties, and particularly exhibits excellent tensile elongation and elongation at break. Due to the improved mechanical properties of the thermally conductive, electrically insulating film of the present application, the thermally conductive, electrically insulating film of the present application is unbreakable during packing, transportation (such as when rolled into rolls for storage and transport), and final molding by manufacturers of electronic products and devices (such as when folded, cut and formed for use in electronic products and devices). For example, the thermally conductive, electrically insulating film of the present application has excellent tenacity, such that the thermally conductive, electrically insulating film of the present application can be folded five times during the course of molding without any damage.

Due to the excellent thermal conduction performance of the thermally conductive, electrically insulating film of the present application, when the thermally conductive, electrically insulating film of the present application is used in electronic products or devices, it can be directly laminated into electronic products or devices without the need for applying a thermally conductive adhesive. Therefore, the thermally conductive, electrically insulating film of the present application is convenient to use, cost-saving, and helps reduce the weight and size of electronic products and devices.

In addition, the thermally conductive, electrically insulating film of the present application can be produced by the common casting film process, so the production process is simple.

The beneficial effects of the thermally conductive, electrically insulating film of the present application are described below by referring to a thermally conductive, electrically insulating film sample of a specific Example and a film sample of a Comparative Example. Table 1 shows the contents of various ingredients of the film samples of the Examples of the present application and the Comparative Example; Table 2 shows the performance data of the film samples of the Examples and the Comparative example.

The film samples of the Examples and Comparative Example in Table 1 were prepared in the following manner: raw materials for various ingredients were weighed according to the contents of ingredients in Table 1, added into a high speed mixer and mixed for 3 min at a rotational rate of 2000 r/min. The mixed raw materials were added into a twin screw extruder, extruded, cooled, and granulated. The temperature of the twin screw extruder was set at 180-230° C., and the rotational rate of the screw was set at 300 r/min. The granular material obtained was dried, extruded into film, and was cut into standard test specimens for performance tests. Samples for thermal conductivity testing were compression molded at 220 degrees using a flat-panel vulcanizer.

TABLE 1
Contents of various ingredients in the films of Examples and Comparative Example

| | Comparative | | | | | | | | |
|---|---|---|---|---|---|---|---|---|---|
| | Example | Example 1 | Example 2 | Example 3 | Example 4 | Example 5 | Example 6 | Example 7 | Example 8 |
| | Percentage | Percentage | Percentage | Percentage | Percentage | Percentage | Percentage | Percentage | Percentage |
| Ingredients | (%) | (%) | (%) | (%) | (%) | (%) | (%) | (%) | (%) |
| PP resin | 18.3 | 24.5 | 32.5 | 17.5 | 27.5 | 27.5 | 26.5 | 19.7 | 26.7 |
| Toughening | 0 | 1.8 | 1.6 | 1.5 | 1.6 | 1.6 | 0 | 10 | 1.3 |
| agent | | | | | | | | | |
| Compatibilizer | 0 | 1.8 | 1.5 | 1 | 1.5 | 1.5 | 1 | 3 | 0 |
| Flame | 21.0 | 26.2 | 24.2 | 15 | 24.2 | 24.2 | 10 | 16 | 20 |
| retardant | | | | | | | | | |
| Graphite | 0 | 4.6 | 4.6 | 4.6 | 2 | 15 | 5 | 10 | 5 |
| Magnesium | 60 | 16.5 | 25 | 50 | 27.6 | 14.6 | 0 | 20 | 0 |
| oxide | | | | | | | | | |
| Aluminum | 0 | 0 | 0 | 0 | 0 | 0 | 55 | — | 5 |
| oxide | | | | | | | | | |
| Boron | 0 | 23.9 | 10 | 10 | 15 | 15 | 2 | 21 | 40 |
| nitride | | | | | | | | | |
| Antioxidant | 0.2 | 0.2 | 0.2 | 0.2 | 0.2 | 0.2 | 0.2 | — | 1.5 |
| Lubricant | 0.5 | 0.5 | 0.4 | 0.2 | 0.4 | 0.4 | 0.3 | 0.3 | 0.3 |
| Total | 100.0 | 100.0 | 100 | 100 | 100 | 100 | 100.0 | 100.0 | 100 |

In Table 1, the PP resin was copolymerized polypropylene resin with a melting point of around 160° C.; the toughening agent was ethene-octene copolymer; the compatibilizer was alkyl silane coupling agent; the flame retardant was phenyl ether brominated flame retardant; the graphite was surface-alkylated flake graphite with a particle size of 1-50 μm; the aluminum oxide was surface-alkylated spherical aluminum oxide with a particle size of 5-20 μm; the magnesium oxide was spherical magnesium oxide with a particle size of 5-30 μm; the boron nitride was flaky boron nitride; the antioxidant was hindered phenolic stabilizer; the lubricant was stearate.

TABLE 2
Performance data for films of Examples and Comparative Example

| Performance | Test | | Comparative | Example | Example | Example | Example | Example | Example | Example | Example |
|---|---|---|---|---|---|---|---|---|---|---|---|
| indicator | standard | Unit | Example | 1 | 2 | 3 | 4 | 5 | 6 | 7 | 8 |
| Density | ASTM | g/cm³ | 2.16 | 1.68 | 1.56 | 1.91 | 1.57 | 1.63 | 1.65 | 1.59 | 1.63 |
| | D-792 | | | | | | | | | | |
| Tensile | ASTM | MPa | 16.3 | 35.8 | 33.5 | 19.3 | 26.9 | 24.2 | 28.3 | 19.2 | 31.9 |
| yield | D-882 | | | | | | | | | | |
| strength | | | | | | | | | | | |
| Elongation | ASTM | % | 9.2 | 65.4 | 122 | 62.2 | 121 | 92.4 | 72.1 | 95 | 114 |
| at break | D-882 | | | | | | | | | | |
| Room- | | | Passed | Passed | Passed | Passed | Passed | Passed | Passed | Passed | Passed |
| temperature, | | | | | | | | | | | |
| 5 KV | | | | | | | | | | | |
| puncture | | | | | | | | | | | |
| test | | | | | | | | | | | |
| Room- | ASTM | KV | 12.85 | 19.96 | — | — | — | — | 19.5 | 9.5 | 20.8 |
| temperature, | D-149 | | | | | | | | | | |
| high- | | | | | | | | | | | |
| voltage | | | | | | | | | | | |
| electrical | | | | | | | | | | | |
| break- | | | | | | | | | | | |
| down | | | | | | | | | | | |
| Surface | | Ω | 10¹³ | 10¹³ | 10¹³ | 10¹³ | 10¹³ | 10¹² | 10¹³ | 10¹² | 10¹³ |
| resistivity | | | | | | | | | | | |
| Flame | UL94 | | V2 | V0 | V0 | V0 | V0 | V0 | V0 | V0 | V0 |
| retardancy | | | | | | | | | | | |
| test | | | | | | | | | | | |
| Thermal | ASTM | W/m · K | 0.94 | 1.08 | 0.82 | 1.44 | 1.01 | 1.12 | 1.0 | 1.2 | 1.1 |
| conductivity | D5470-12 | | | | | | | | | | |

From the aforesaid Table 1 and Table 2, it can be seen that the amount of thermally conductive filler added into the film of the Comparative Example was 60%, the amount of PP resin was 18.3%, and the thermally conductive material only comprised magnesium oxide; the thermal conductivity of the film of the Comparative Example was up to 0.94 W/m·K, but its tensile yield strength was only 16.3 MPa and its elongation at break was only 9.2%. This indicates that the film of the Comparative Example met the requirement for thermal conductivity, but its mechanical properties were poor.

In various Examples of the present application, by using three types of thermally conductive fillers, the thermal conductivity of the film could be maintained at a level generally equal to or higher than the thermal conductivity of the Comparative Example. With the increase in the content of the thermally conductive filler, the thermal conductivity of the film was also increased accordingly. In Examples 1, 2, 4, 5, 7 and 8, the amount of the thermally conductive filler used was smaller than that of the Comparative Example, but a thermal conduction performance comparable to or better than that of the Comparative Example was obtained. In Examples 3 and 6, where a large amount of thermally conductive filler was used (64.6% in Example 3, 62% in Example 6), the thermal conductivity of the film was even higher.

Meanwhile, since the amount of the thermally conductive filler in the Examples was smaller than in the Comparative Example, a larger amount of PP resin could be used for the film of the Examples. As shown in Table 2, with the increase in the amount of PP resin, the mechanical properties of the film of the Examples were improved. For example, the tensile yield strength and elongation at break were obviously better than those of the Comparative Example, indicating that the films of the Examples exhibited better tenacity. Even in Example 3, where the amount of PP resin was smaller than in the Comparative Example, by adding the toughening agent and the compatibilizer, the film exhibited slightly better mechanical properties than that of the Comparative Example.

Moreover, as shown in Table 2, although flake graphite was used as the thermally conductive additive, the thermally conductive, electrically insulating film of the Examples still exhibited the same electrical insulation performance as the film of the Comparative Example. In addition, the thermally conductive, electrically insulating film of the present application exhibited better flame retardancy performance and voltage breakdown performance than that of the Comparative Example. As shown in Table 2, the thermally conductive, electrically insulating film of the present application provided better overall performance than the film of the Comparative Example, and its film weight per unit volume was also lighter, making it cater to the development trend in electronic products and devices towards small size and light weight.

The thermally conductive, electrically insulating film of the present application may be used in various electronic products and devices to help dissipate heat from electronic products and devices. Such electronic products or devices may be a battery pack, notebook computer, and power supply adapter for a computer.

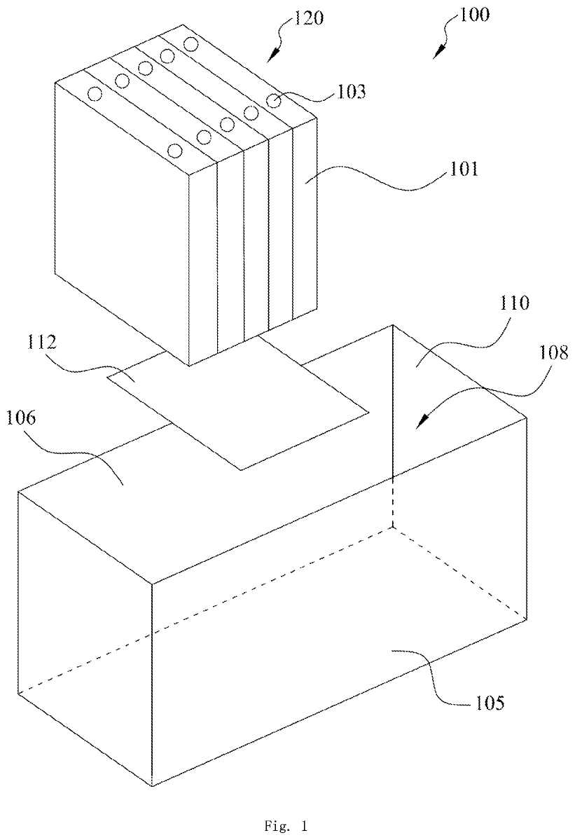

FIG. 1 is a schematic structure diagram for one embodiment of the battery pack comprising the thermally conductive, electrically insulating film of the present application, wherein only a partial breakdown structure of the battery pack is shown to better illustrate the location of the thermally conductive, electrically insulating film. As shown in FIG. 1, the battery pack 100 comprises a battery pack module 120 comprising a plurality of battery units 101 and a battery pack housing 110. The battery pack housing 110 comprises a top wall (not indicated in the FIGURE) and a bottom wall 105 which are oppositely arranged, and four side walls 106 that surround and connect the top wall and the bottom wall 105. The battery pack module 120 is contained in the housing cavity 108 defined by the top wall, bottom wall 105 and side walls 106. Each battery unit 101 has individual connection terminals 103. The individual connection terminals 103 of these battery units 101 are electrically connected according to a predetermined circuit, and then these battery units can provide power and/or be charged through the main connection terminal (not indicated in the FIGURE) on the battery pack housing 110.

The thermally conductive, electrically insulating film 112 is disposed between the battery pack module 120 and the bottom wall 105 of the battery pack housing 110. Through the thermally conductive, electrically insulating film 112, the heat energy generated by the battery pack module 120 during operation can be timely dissipated into the external environment via the bottom wall 105 of the battery pack housing 110, rather than accumulating in the housing cavity 108 of the battery pack housing 110.

It should be noted that in the Example as shown in FIG. 1, although the thermally conductive, electrically insulating film 112 is disposed between the battery pack module 120 and the bottom wall 105 of the battery pack housing 110, it also can be disposed between the battery pack module 120 and the side wall 106 of the battery pack housing 110 based on the actual needs for space design and heat dissipation.

Finally, the thermally conductive, electrically insulating film of the present application has various beneficial technical effects, and at least partial technical effects of the thermally conductive, electrically insulating film of the present application are listed below:
1. Excellent thermal conduction performance meets the requirements for thermal conduction and heat dissipation for electronic products and devices.
2. Excellent mechanical properties make it unbreakable during transportation, packing and the processing of the manufacturers of electronic products and devices.
3. Outstanding electrical insulation performance to meet the insulativity requirement for electronic products and devices.
4. Simple production process.
5. It is convenient to use, cost-saving, and helps reduce the weight and size of electronic products and devices.
6. Its film weight per unit volume is also lighter, making it cater to the development trend in electronic products and devices towards small size and light weight.

Although the present application is described by referring to specific embodiments indicated in the attached drawing, it should be understood that several variations to the thermally conductive, electrically insulating film of the present application may be made without departing from the spirit, scope and context of the teaching of the present application. Those skilled in the art will realize that different ways to change the structure of the embodiments disclosed in the present application fall within the spirit and scope of the present application and Claims.

1. A thermally conductive, electrically insulating film, comprising:
a thermoplastic resin accounting for 15-50% of the weight of the thermally conductive, electrically insulating film; and
a thermally conductive filler accounting for 40-70% of the weight of the thermally conductive, electrically insulating film;
wherein, the thermally conductive filler comprises: a thermally conductive carbon-based filler, a thermally conductive metal oxide or hydroxide filler and a thermally conductive ceramic filler.

2. The thermally conductive, electrically insulating film as claimed in claim 1, wherein
the thermally conductive carbon-based filler accounts for 2-15% of the weight of the thermally conductive, electrically insulating film.

3. The thermally conductive, electrically insulating film as claimed in claim 2, wherein
the thermally conductive carbon-based filler accounts for 10-15% of the weight of the thermally conductive, electrically insulating film.

4. The thermally conductive, electrically insulating film as claimed in claim 1, wherein
the thermally conductive carbon-based filler is one or more fillers selected from graphite, carbon nanotube and graphene.

5. The thermally conductive, electrically insulating film as claimed in claim 4, wherein
the graphite is at least one graphite selected from flake graphite and expanded graphite.

6. The thermally conductive, electrically insulating film as claimed in claim 5, wherein
the thermally conductive carbon-based filler is flake graphite.

7. The thermally conductive, electrically insulating film as claimed in claim 4, wherein
the graphite has a particle size ranging from 10 nm to 200 μm, the carbon nanotube has a diameter ranging from 2 to 200 nm, and the graphene has a diameter-to-thickness ratio ranging from 500 to 8000.

8. The thermally conductive, electrically insulating film as claimed in claim 1, wherein
the thermally conductive metal oxide or hydroxide filler accounts for 5-55% of the weight of the thermally conductive, electrically insulating film.

9. The thermally conductive, electrically insulating film as claimed in claim 8, wherein
the thermally conductive metal oxide or hydroxide filler accounts for 20-50% of the weight of the thermally conductive, electrically insulating film.

10. The thermally conductive, electrically insulating film as claimed in claim 1, wherein
the thermally conductive metal oxide or hydroxide filler comprises one or more fillers selected from magnesium oxide, zinc oxide, aluminum oxide, magnesium hydroxide, and aluminum hydroxide.

11. The thermally conductive, electrically insulating film as claimed in claim 10, wherein
the thermally conductive metal oxide or hydroxide filler is granular.

12. The thermally conductive, electrically insulating film as claimed in claim 1, wherein
the thermally conductive ceramic filler accounts for 2-50% of the weight of the thermally conductive, electrically insulating film.

13. The thermally conductive, electrically insulating film as claimed in claim 12, wherein
the thermally conductive ceramic filler accounts for 5-40% of the weight of the thermally conductive, electrically insulating film.

14. The thermally conductive, electrically insulating film as claimed in claim 1, wherein
the thermally conductive ceramic filler comprises one or more fillers selected from boron nitride, silicon carbide, and aluminum nitride.

15. The thermally conductive, electrically insulating film as claimed in claim 14, wherein
the thermally conductive ceramic filler is flaky or spherical.

16. The thermally conductive, electrically insulating film as claimed in claim 1, wherein
the thermoplastic resin is polypropylene resin.

17. The thermally conductive, electrically insulating film as claimed in claim 1, wherein
the thermally conductive, electrically insulating film further comprises a flame retardant accounting for 10-45% of the weight of the thermally conductive, electrically insulating film.

18. The thermally conductive, electrically insulating film as claimed in claim 17, wherein
the flame retardant is at least one compound selected from phosphorus/nitrogen-containing flame retardant, phosphorus/nitrogen/silicon-containing flame retardant, and brominated flame retardant.

19. A battery pack, comprising:
a battery pack housing comprising a bottom wall and side walls;
a battery pack module disposed inside the battery pack housing; and
the thermally conductive, electrically insulating film of claim 1, disposed between the battery pack module and at least one of the bottom wall and side walls of the battery pack housing.
